(19) United States
(12) Patent Application Publication
(10) Pub. No.: US 2011/0123767 A1
(43) Pub. Date: May 26, 2011

(54) COATING OF A BODY MADE OF STEEL OR CARBON-FIBER REINFORCED PLASTIC MATERIAL, AND METHOD FOR PRODUCING SUCH A COATING

(76) Inventors: Gerhard Johner, Gelnhausen (DE); Marku Kirst, Buttelborn (DE); Christian Dudazy, Bruchkobel (DE)

(21) Appl. No.: 12/919,065

(22) PCT Filed: Feb. 25, 2009
(86) PCT No.: PCT/EP2009/052236

§ 371 Date: Oct. 27, 2010

(30) Foreign Application Priority Data
Mar. 4, 2008 (DE) 10200801238.0

(51) Int. Cl. B32B 15/08; B05D 1/36; B32B 5/00; B32B 27/34

(52) U.S. Cl. 428/141; 427/203; 427/331; 427/409; 427/412.1; 427/419.3; 428/339; 428/446; 428/457; 428/458; 428/477.7; 428/702

(57) ABSTRACT

There is provided a coating for a body of steel or a carbon fiber reinforced plastic material, particularly a roller, with an adhesion-promoting layer of thermoplastic that is deposited on the body, in the surface near material matrix of which solid (powder) particles are embedded in a form-fitting adhering manner such that only a partial region of these particles projects from the adhesion promoting layer, as well as with a functional layer of oxide ceramic or wear-resistant hard metal overlaying the adhesion-promoting layer, in which the partial regions of the particles projecting from the adhesion-promoting layer are embedded. For producing such a coating, the adhesion-promoting layer preferably is heated to a honey-like viscosity, and powder particles are injected, for example by thermal spraying, into the surface near material matrix of the heated adhesion-promoting layer in a form-fitting adhering manner such that only the tips of these particles project. These tips connect to subsequently deposited powder particles which form the functional layer of oxide ceramic such as Al₂O₃, Cr₂O₃, TiO₂, SiO₂ or ZrO₂ or mixtures therefrom and/or wear resistant hard metal such as WC/Co, Cr₃C₂/NiCr, NiCrBSi, WC/Ni, TiC/Ni, molybdenum, or chromium or mixtures or alloys thereof

The invention relates to a coating of a body of steel or a carbon fiber reinforced plastic material, particularly of a roller having an adhesion-promoting layer applied on the body, and a functional layer of oxide ceramic and/or wear-resistant hard metal superimposing the adhesion-promoting layer. The invention further relates to a method for producing such a coating.

A coating of this type that is provided on a carbon fiber reinforced plastic body is known from DE 10 2005 008 487 A1. Here the adhesion-promoting layer consists of a ductile metal which is selected from the group consisting of copper, nickel, iron, lead, tin and molybdenum which is deposited by plasma spraying or by flame spraying.

Furthermore, steel rollers which are coated with RILSAN®, that is polyamides on the basis of castor oil and PA 11 on the basis of lactame Rilsan, in particular polyamides of 11-aminoundecanoic acid (Rilsan B, PA 11) and of w-laurolactam (Rilsan A, PA 12), since many years belong to the standard equipment in inking systems of modern offset printing machines (DE 35 19 134 C1, JP 56 077 149, JP 2005 271 407). They are considered to be unproblematic in terms of subsurface corrosion or wear. The ink friendliness of the RILSAN-surfaces is of particular advantage, so that this characteristic has resulted in that the formerly common copper coatings of steel rollers in inking systems of offset printing machines were replaced long ago. In the most common offset process, the so-called wet offset process, a water film containing an additive is supplied to the printing plate (dampening unit) and also a film of ink that has been emulsified with this water (inking system). The water in combination with the additive can be very corrosive, and hence corrosion damages in so-called dampening system film rollers which are coated with chromium or ceramic are well-known. On the other hand, corrosion damages on rollers of inking systems that are coated with RILSAN® are generally unheard-of, although these rollers likewise are corrosively exposed due to the water that is emulsified in the ink. RILSAN®-coated rollers of inking systems are considered to be extremely corrosion resistant and only exhibit subsurface corrosion in case that the RILSAN® coating has been locally destroyed.

It is an object of the invention to provide a coating which not only is extremely resistant to chemicals and corrosion, but which furthermore provides for a particularly high wear resistance.

This object is solved by the coating in accordance with claim 1 as well as by the method in accordance with claim 10.

The coating for a body that is made of steel or a carbon fiber reinforced plastic material in accordance with the invention, particularly a roller, comprises an adhesion-promoting layer of thermoplastic that is applied to the body and in the near-surface material matrix of which solid (powder) particles are embedded in a form-fitting adhering manner such that only a partial region of these powder particles projects from the adhesion promoting layer. The adhesion promoting layer is covered with a functional layer of oxide ceramic and/or a wear resistant hard metal, into which the partial regions of the powder particles projecting from the adhesion promoting layer are embedded. The thus embedded powder particles preferably can consist of the same material as the functional layer and hence can comprise oxide ceramic and/or hard metal. Generally, solid particles of any desired chemical composition can be used.

In accordance with the method of the invention for producing a coating of a body of steel or a carbon fiber reinforced plastic material, particularly a roller, first an adhesion-promoting layer of a thermoplastic is deposited on the body. This adhesion-promoting layer preferably is heated to a honey-like viscosity. Solid (powder) particles are embedded in a form-fitting adhering manner into the surface-near material matrix of the thus heated adhesion promoting layer such that only a partial region of these powder particles projects from the adhesion promoting layer. The thus prepared adhesion promoting layer is coated with a functional layer of oxide ceramic and/or wear resistant hard metal, into which the partial regions of the powder particles that project from the adhesion-promoting layer are embedded in the course of the coating process. Embedding of the projecting solids particles into the surface-near material matrix of the adhesion-promoting layer generally can be provided in a different manner, for example by dispersing using a sand-blast system, a calander system or the like.

The adhesion promoting layer preferably consists of a thermoplastic polyamide, and particularly of the materials that are known under the trade names RILSAN®, NYLON and PERLON®, i.e. polyamides on the basis of castor oil and PA 11 on the basis of lactame (RILSAN), of PA 4, PA 11 (NYLON) or PA 6 (PERLON®). Such thermoplastic coatings allow the use of lower alloyed construction steels that are not protected against corrosion or of carbon fiber reinforced plastic materials.

The particles projecting from the adhesion-promoting layer provide for a particularly adhering connection of the adhesion-promoting layer which projects against corrosion with the wear resistant functional layer which preferably is deposited by thermal spraying of for example oxide ceramics. such as chromium oxide, aluminum oxide, titanium dioxide, quartz-containing mullite, zirconium oxide, and their mixtures, as well as hard metals from the group of tungsten carbide/cobalt, tungsten carbide/nickel, titanium carbide/nickel, nickel-chromium/chromium carbide, nickel-chromium-boron-silicon, fused carbide (pure chromium carbide), chromium, molybdenum with oxygen.

In the course of coating, preferably by thermal spraying, the adhesion-promoting layer that has been heated to a honey-like viscosity, the first powder particles are injected in a form-fitting adhering manner into the matrix of the heated thermoplastic, such that only the tips of these powder particles project, and then provide for a connection with the then following powder particles forming the functional layer and comprising oxide ceramic such as Al2O3, Cr2O3, TiO2, SiO2, or ZrO2, or mixtures thereof, or of wear resistant hard metals, such as WC/Co, Cr3C2/NiCr, NiCrBSi, WC/Ni, TiC/Ni, molybdenum, chromium etc. As mentioned above, it also is possible to provide the above mentioned solid particles of any desired chemical composition in a different manner into the surface-near material matrix.

Optionally, these outer coatings furthermore can be provided with an anti-adhesion sealing as it is described in EP 0 999 043 A1.

In the preferred embodiment the thermoplastic layer comprises a thickness of 0.1 to 3.0 mm, preferably of 0.7 mm.

In dependency of its use, surface qualities are required which require a grinding or polishing step after the coating step, so that the functional layer on the coating of thermoplastics comprises a surface roughness which preferably is 0.5 μm<R_{z}<500 μm, and preferably is R_{z}=1.5 to 20 μm.

The sole FIGURE shows exemplary possibilities of use for the coating of the invention in a wet offset printing machine.

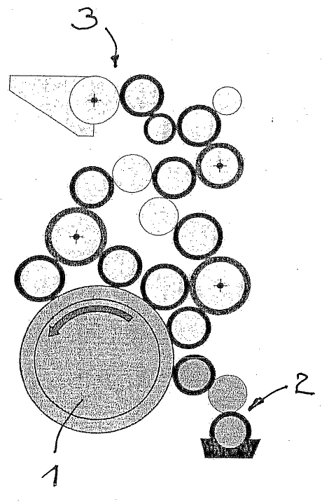

In a manner known per se a printing plate that is mounted on a plate cylinder 1 receives ink from an ink system 2 at the printing positions and at the non-printing regions receives water from a dampening system 3. Particularly the plate cylinder 1 and the rollers which in FIG. 1 have a light color preferably can comprise a coating as it is described above.

1-22. (canceled)

23. A coating for a body of steel or a carbon fiber reinforced plastic roller comprising:
an adhesion-promoting layer of thermoplastic applied to the body, the adhesion-promoting layer having a near surface particle matrix in which solid powder particles are embedded in a form-fitting adhering manner such that only a partial region of these particles projects from a surface of the adhesion-promoting layer, and
a functional layer of oxide ceramic or a wear resistant hard metal or both covering the surface of the adhesion-promoting layer;
wherein the partial regions of the particles projecting from the surface of the adhesion-promoting layer are embedded into the functional layer.

24. The coating of claim 1 wherein the oxide ceramic is selected from the group consisting of Al₂O₃, Cr₂O₃, TiO₂, SiO₂, or ZrO₂ or mixtures of two or more of these materials.

25. The coating of claim 1 wherein the hard metal is selected from the group consisting of WC/Co, Cr₃C₂/NiCr, NiCrBSi, WC/Ni, TiC/Ni, molybdenum or chromium, or a mixture or an alloy of two or more of these materials.

26. The coating of claim 1 wherein the solid powder particles embedded within the near surface particle matrix of the adhesion-promoting layer comprise the same material as the functional layer.

27. The coating of claim 1 wherein a surface of the functional layer is grinded or polished.

28. The coating of claim 1 wherein a surface of the functional layer has a surface roughness in the range of 0.5 μm<R_{z}<500 μm.

29. The coating of claim 1 wherein the adhesion-promoting layer has a thickness of about 0.1 mm to about 3.0 mm.

30. The coating of claim 1 wherein the adhesion-promoting layer comprises a polyamide.

31. The coating of claim 30 wherein the adhesion-promoting layer comprises a RILSAN®, NYLON or PERLON®.

32. A method for producing a coating of a body of steel or carbon fiber reinforced plastic roller comprising the steps of:
applying an adhesion-promoting layer of thermoplastic to the body, the adhesion-promoting layer having a near surface particle matrix with embedded solid powder particles in the adhesion-promoting layer in a form-fitting adhering manner such that only a partial region of these solid powder particles projects from a surface of the adhesion promoting layer, and
covering the surface of the adhesion promoting layer with a functional layer of oxide ceramic or a wear resistant hard metal or both;
wherein the partial regions of the solid powder particles projecting from the surface of the adhesion promoting layer are embedded in the functional layer.

33. The method of claim 32 wherein the adhesion promoting layer is heated to a honey-like viscosity for embedding the solid powder particles therein.

34. The method of claim 33, wherein the particles are injected into the near surface particle matrix of the heated adhesion promoting layer.

35. The method of claim 33, wherein the injection of the particles is provided by thermal spraying.

36. The method of claim 32 wherein the functional layer is provided by thermal spraying onto the adhesion-promoting layer that has been provided with particles projecting therefrom, and wherein the partial regions of the particles are embedded in a form-fitting adhering manner into the functional layer.

37. The method of claim 32, wherein during the coating operation the body is moved with a relative velocity of at least 0.2 m/s relative to the coating apparatus used and is maintained at a temperature of no more than 200° C. by cooling measures.

38. The method of claim 32 wherein the adhesion-promoting layer has a thickness of about 0.1 mm to about 3.0 mm.

39. The method of claim 32 wherein the surface of the functional layer is grinded or polished.

40. The method of claim 39 wherein the surface of the functional layer is grinded or polished to a surface roughness of 0.5 μm<R_{z}<500 μm.

41. The method of claim 32 wherein the adhesion-promoting layer comprises a polyamide.

42. The method of claim 41 wherein the adhesion-promoting layer is made of RILSAN®, NYLON or PERLON®.

43. The method of claim 32 wherein the functional layer is selected from the group consisting of Al₂O₃, Cr₂O₃, TiO₂, SiO₂, or ZrO₂, or of a mixture of two or more of these materials.

44. The method of claim 32 wherein the functional layer is selected from the group consisting of WC/Co, Cr₃C₂/NiCr, NiCrBSi, WC/Ni, TiC/Ni, molybdenum, or chromium or of a mixture or an alloy of two or more of these materials.
